(19) United States
(12) Patent Application Publication
(10) Pub. No.: US 2026/0306993 A1
(43) Pub. Date: Oct. 8, 2026

(54) SYSTEMS FOR OPTIMIZING CARBON DIOXIDE CAPTURE

(71) Applicant: GE Vernova Infrastructure Technology LLC, Greenville, SC (US)

(72) Inventors: Szymon Pawel MODELSKI, Schenectady, NY (US); Douglas BEADIE, Schenectady, NY (US); Anindya Kanti DE, Schenectady, NY (US); Raub Warfield SMITH, Schenectady, NY (US)

(21) Appl. No.: 19/480,708

(22) PCT Filed: May 9, 2023
(86) PCT No.: PCT/US2023/021536

§ 371 Date: Oct. 31, 2025

(51) Int. Cl. B01D 53/04

(52) U.S. Cl. CPC B01D 53/0454; B01D 53/0438; B01D 53/0446; B01D 2257/504

(57) ABSTRACT

A capture system for use in capturing carbon dioxide, the capture system including at least one adsorbent bed including a sorbent. The at least one adsorbent bed is oriented to receive a gas stream, adsorb carbon dioxide from the gas stream via the sorbent, and discharge an exhaust stream. The capture system includes a contactor in close proximity to the adsorbent bed, the contactor oriented to receive a regulating fluid for use in indirectly controlling a temperature of the adsorbent bed, and a pressure assembly oriented to control a pressure of the exhaust stream discharged from the adsorbent bed. The capture system also includes a controller configured to modulate the temperature and the pressure of the adsorbent bed to facilitate increasing an amount of carbon dioxide captured by the capture system.

### BACKGROUND OF THE INVENTION

The present disclosure relates generally to capture systems and, more specifically, to systems that facilitate optimizing the adsorption and desorption of carbon dioxide gas by an adsorbent bed using changes in temperature and pressure.

At least some known industrial and power generation processes may result in the production of a gas stream containing contaminants, such as carbon dioxide (CO₂). To facilitate removing the contaminants from the gas stream prior to an exhaust stream being released into the atmosphere, at least some known systems include a capture system. For example, capture systems may be used to capture CO₂ and store the CO₂ underground to facilitate reducing an amount of CO₂ undesirably released into the atmosphere.

At least some known capture systems use an adsorbent bed to capture CO₂. In some of such capture systems, a sorbent material may be used with the adsorbent bed to enhance the adsorption and desorption of CO₂. To facilitate increasing the amount of CO₂ captured, at least some known capture systems use direct heating and cooling of the adsorbent bed. However, direct heating and cooling may contaminate the sorbent material. Additionally, allowing the temperature of the adsorbent bed to increase during adsorption may reduce the efficiency of the capture system. Accordingly, there exists a need for capture systems that use changes in temperature in combination with changes in pressure to optimize the efficiency and productivity of carbon dioxide adsorption and desorption.

### BRIEF DESCRIPTION OF THE INVENTION

In one aspect, a capture system for use in capturing carbon dioxide is provided. The capture system includes at least one adsorbent bed including a sorbent, the at least one adsorbent bed oriented to receive a gas stream, adsorb carbon dioxide from the gas stream via the sorbent, and discharge an exhaust stream. The capture system also includes a contactor in close proximity to the adsorbent bed, the contactor oriented to receive a regulating fluid for use in indirectly controlling a temperature of the adsorbent bed, and a pressure assembly oriented to control a pressure of the exhaust stream discharged from the adsorbent bed. The capture system further includes a controller configured to modulate the temperature and the pressure of the adsorbent bed to facilitate increasing an amount of carbon dioxide captured by the capture system.

In another aspect, a capture system for use in capturing carbon dioxide is provided. The capture system includes at least one adsorbent bed including a plate coated with a sorbent, the at least one adsorbent bed oriented to receive a gas stream, adsorb carbon dioxide from the gas stream via the sorbent, and discharge an exhaust stream. The capture system also includes a contactor in close proximity to the adsorbent bed, the contactor oriented to receive a regulating fluid for use in indirectly controlling a temperature of the adsorbent bed, and a pressure assembly oriented to control a pressure of the exhaust stream discharged from the adsorbent bed. The capture system further includes a controller configured to modulate the temperature and the pressure of the adsorbent bed to facilitate increasing an amount of carbon dioxide captured by the capture system.

### BRIEF DESCRIPTION OF THE DRAWINGS

FIG. 1 is a schematic illustration of an exemplary capture system that may be used to capture CO₂.

FIG. 2 is a perspective schematic illustration of an exemplary adsorption module that may be used with the capture system of FIG. 1.

FIG. 3 is a schematic illustration of an alternative capture system that may be used to capture CO₂.

FIG. 4 is a schematic of an exemplary control system that may be used with the capture systems of FIG. 1 and FIG. 3.

### DETAILED DESCRIPTION OF THE INVENTION

The embodiments described herein relate to systems that use changes in temperature and pressure to optimize the adsorption and desorption of carbon dioxide by an adsorbent bed. The advantages of the systems described herein, over the prior art, include, at least: (i) minimizing the contamination of the sorbent due to the use of convection between the first stream flowing within the fluid circuit of the contactor and the sorbent coated on the plate of the adsorbent bed; (ii) increasing the efficiency and performance of carbon dioxide adsorption due to the use of changes in temperature of the adsorbent bed; (iii) increasing the efficiency and performance of carbon dioxide desorption due to the use of changes in both temperature and pressure of the adsorbent bed; and (iv) increasing the performance of the capture system due to the use of multiple adsorbent beds connected in series by valves.

When introducing elements of various embodiments disclosed herein, the articles “a,” “an,” “the,” and “said” are intended to mean that there are one or more of the elements. The terms “comprising,” “including,” and “having” are intended to be inclusive and mean that there may be additional elements other than the listed elements.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

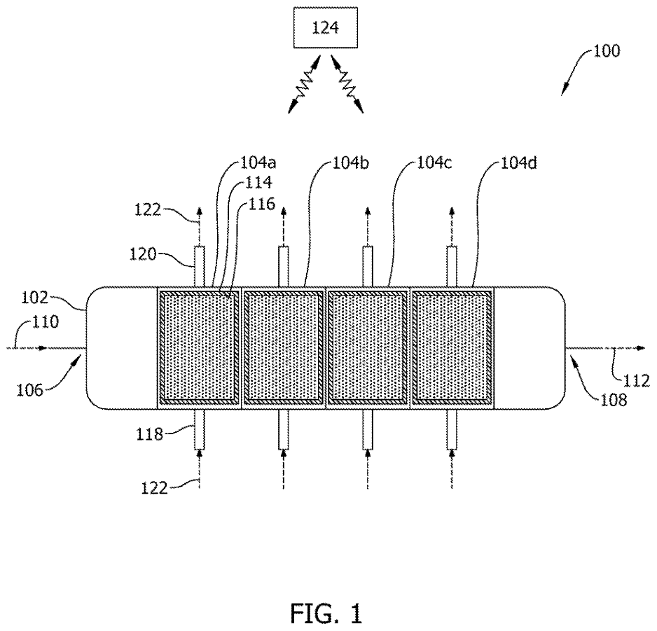

FIG. 1 is a schematic illustration of an exemplary capture system 100 that may be used to capture CO₂ using an adsorbent bed 102. In the exemplary embodiment, the adsorbent bed 102 includes at least one adsorption module 104. More specifically, in the exemplary embodiment, adsorbent bed 102 includes four adsorption modules 104a-d. In some embodiments, capture system 100 may include more or less than four adsorption modules 104. Moreover, in the exemplary embodiment, the adsorbent bed 102 includes an inlet 106 and an outlet 108. The inlet 106 and the outlet 108 are oriented such that during operation, a gas stream 110 received through the inlet 106 is channeled through each adsorption module 104 in series towards the outlet 108. As the gas stream 110 is channeled through each adsorption module 104, the adsorbent bed 102 captures CO₂ from the gas stream 110 and discharges an exhaust stream 112 through the outlet 108 that is depleted of CO₂.

Generally, the gas stream 110 may be any suitable gas known in the art that includes targeted contaminants. For example, the gas stream 110 may be air, flue gas, post-combustion gas, natural gas, and/or combinations thereof. In the exemplary embodiment, the gas stream 110 includes CO₂. In some embodiments, CO₂ may be present in the gas stream 110 in a range of from about 400 ppm to about 15v %. In other embodiments, CO₂ may be present in the gas stream 110 in a range of from about 0.04v % to about 30v %.

In the exemplary embodiment, the concentration of CO₂ of the gas stream 110 is generally at its highest as the gas stream 110 enters the inlet 106. As CO₂ is adsorbed by each subsequent adsorption module 104, the concentration of CO₂ in the gas stream 110 is reduced as the gas stream 110 is channeled through the adsorption modules 104a-d towards the outlet 108. In the exemplary embodiment, the concentration of CO₂ in the gas stream 110 flowing through the adsorption modules 104a-d is at its lowest at the outlet 108.

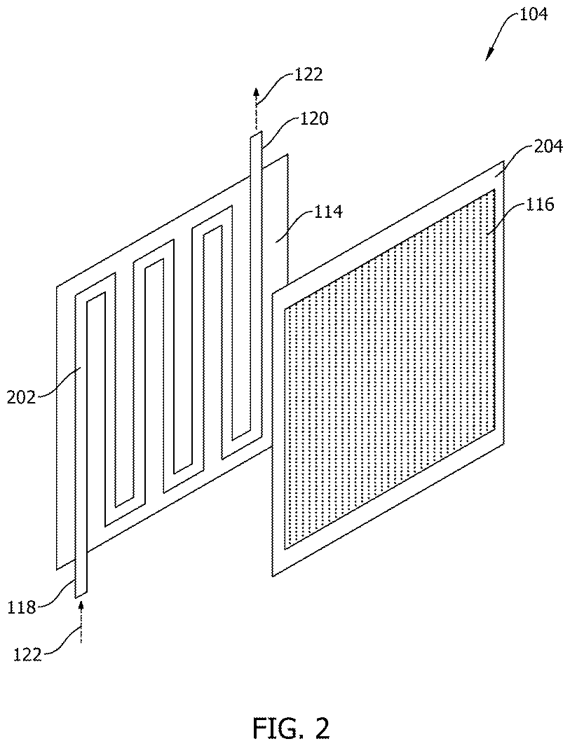

In the exemplary embodiment, the adsorption module 104 includes a contactor 114. The contactor 114 includes a contactor inlet 118, a contactor outlet 120, and a fluid circuit 202 (shown in FIG. 2) defined between and extending from the contactor inlet 118 to the contactor outlet 120. In the exemplary embodiment, the adsorption module 104 also includes a plate 204 (shown in FIG. 2) on which a sorbent 116 is coated, in a solid form, to facilitate adsorbing CO₂. For example, the sorbent 116 may be, but is not limited to only being, in the form of powder, composites mixed with binders, films or coating, packed bed, and/or columns. In some embodiments, the sorbent 116 may be the same within each adsorption module 104. In other embodiments, the sorbent 116 may be different within at least one adsorption module 104. In the exemplary embodiment, the contactor 114 and the plate 204 are adjacent to each other to facilitate indirect heating and/or cooling of the sorbent 116 coated on the plate 204.

In the exemplary embodiment, a first stream 122 received through the contactor inlet 118 facilitates modulating the temperature of the sorbent 116 coated on the plate 204 via heat transfer between the first stream 122 flowing within the fluid circuit 202 (shown in FIG. 2) and the plate 204. For example, a regulated temperature T_{reg} of the first stream 122 may be used to increase or decrease a control temperature T_{cntl} of the adsorption module 104. In some embodiments, the first stream 122 may be in a liquid form. In other embodiments, the first stream 122 may be in a gaseous form. Convection between the first stream 122 flowing through the fluid circuit 202 and the sorbent 116 coated on the plate 204 facilitates controlling a temperature of the sorbent 116 without the risk of contamination that could occur from direct contact with the first stream 122.

In the exemplary embodiment, the capture system 100 also includes a controller 124 that dynamically adjusts operation of the capture system 100. For example, the controller 124 may facilitate optimizing the capture of CO₂ by changing the control temperature T_{cntl} of one or more adsorption module 104 and/or changing the regulated temperature T_{reg} of the first stream 122, as described further herein.

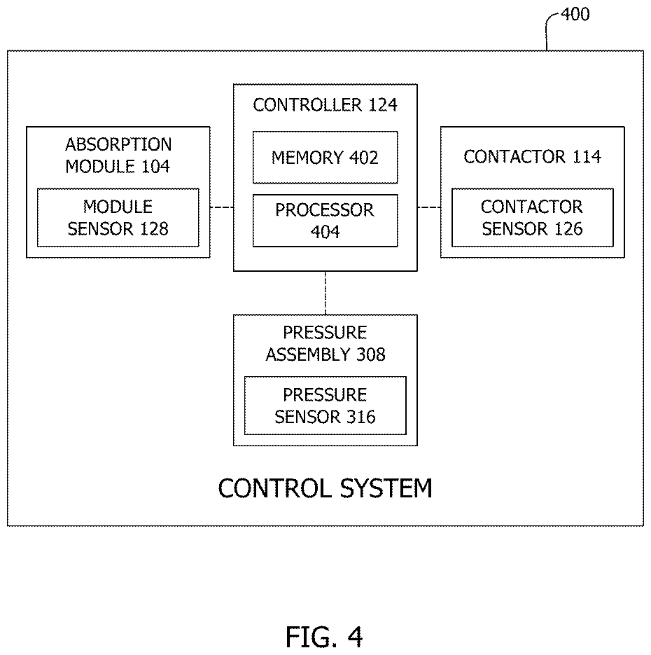

The controller 124 facilitates modulating the temperature of each adsorption module 104a-d by monitoring the temperature of the first stream 122 and/or the temperature of the sorbent 116 across the plate 204 (shown in FIG. 2). For example, the controller 124 may monitor the regulated temperature T_{reg} of the first stream 122 using a contactor sensor 126 (shown in FIG. 4). Additionally, for example, the controller 124 may monitor the control temperature T_{cntl} of at least one adsorption module 104 using a module sensor 128 (shown in FIG. 4). In operating conditions where the control temperature T_{cntl} of at least one adsorption module 104 is lower than desired, the controller 124 may selectively increase the regulated temperature T_{reg} of the first stream 122, thereby indirectly increasing the temperature of the at least one adsorption module 104. Alternatively, in operating conditions where the control temperature T_{cntl} of at least one adsorption module 104 is higher than desired, the controller 124 may selectively decrease the regulated temperature T_{reg} of the first stream 122, thereby indirectly reducing the temperature of the at least one adsorption module 104.

Generally, the regulated temperature T_{reg} of the first stream 122, and thereby the temperature of the adsorption module 104, may be any suitable temperature known in the art that facilitates the capture of CO₂ by the systems described herein. In the exemplary embodiment, the regulated temperature T_{reg} of the first stream 122 is monitored within each adsorption module 104a-d. In some embodiments, the regulated temperature T_{reg} of the first stream 122 may be substantially uniform across each adsorption module 104. In other embodiments, the regulated temperature T_{reg} of the first stream 122 may vary across different adsorption modules 104a-d.

Additionally, the controller 124 may vary the regulated temperature T_{reg} of the first stream 122 within any of the adsorption modules 104a-d. For example, one or more adsorption modules 104a-d may include one or more module sensors 128 (shown in FIG. 4). Thus, the controller 124 may create a temperature profile that includes varied values of the regulated temperature T_{reg} of the first stream 122 within any or all of the adsorption modules 104a-d.

The regulated temperature T_{reg} of the first stream 122 may be based on the temperature of an extraction flow (not shown) from a steam turbine (not shown). For example, the steam turbine may be part of a combined cycle power plant (not shown), with the extraction flow from the steam turbine being used to change the temperature of the first stream 122. In some embodiments, the extraction flow may heat the first stream 122 through convective transfer via one or more heat exchangers (not shown).

FIG. 2 is a schematic illustration of the adsorption module 104 including the contactor 114 and the plate 204. In the exemplary embodiment, the contactor 114 includes the fluid circuit 202 extending between the contactor inlet 118 and the contactor outlet 120. The plate 204 is coated with the sorbent 116 to adsorb CO₂. In the exemplary embodiment, the contactor 114 and the plate 204 are in close proximity to each other to facilitate indirect heating and/or cooling of the sorbent coated on the plate 204.

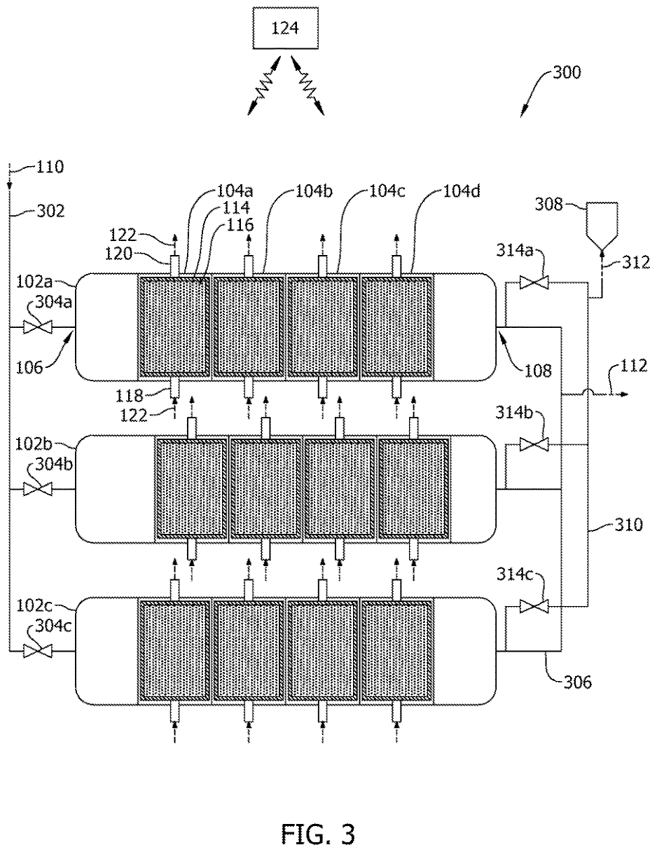

FIG. 3 is a schematic illustration of an exemplary capture system 300 that may be used to capture CO₂ using a plurality of adsorbent beds 102. In the exemplary embodiment, system 300 includes three adsorbent beds 102a-c. The capture system 300 illustrated in FIG. 3 is similar to the capture system 100 (shown in FIG. 1), with the differences noted below, and as such, the same reference numbers for the same components are used in FIG. 3 as were used in FIG. 1. In the exemplary embodiment, the inlet 106 of each adsorbent bed 102 is connected in parallel by an inlet line 302. In some embodiments, capture system 300 may include more or less than three adsorbent beds 102a-c. In the exemplary embodiment, the gas stream 110 is channeled through the inlet line 302, wherein the flow of the gas stream 110 through each respective adsorbent bed 102 is controlled via a plurality of respective inlet valves 304. In the exemplary embodiment, each inlet valve 304 is in communication with the controller 124 to enable the controller 124 to selectively control the flow of the gas stream 110 from the inlet line 302 through the corresponding adsorbent bed 102. For example, in the exemplary embodiment, inlet valve 304a controls a flow of gas stream 110 to adsorbent bed 102a.

In the exemplary embodiment, the outlet 108 of each adsorbent bed 102a-c is coupled in series by an outlet line 306 such that the exhaust stream 112 is channeled from each adsorbent bed 102 through the outlet line 306 to be discharged from capture system 300. In the exemplary embodiment, the outlet 108 of each adsorbent bed 102 is also coupled to a pressure assembly 308 via a pressure line 310. The exhaust stream 312 is channeled through the pressure line 310, with the pressure of the exhaust stream 312 from each adsorbent bed 102 controlled via a plurality of pressure valves 314. Each pressure valve 314 may be in communication with the controller 124 to enable the controller 124 to control the pressure of the exhaust stream 312 from the adsorbent bed 102 through the pressure line 310 into the pressure assembly 308. For example, in the exemplary embodiment, the pressure valve 314a controls the pressure of the exhaust stream 312 through the pressure line 310 from the adsorbent bed 102a, with the exhaust stream 312 being used to operate the adsorbent bed 102a under vacuum.

Generally, the pressure assembly 308 may be any suitable pressure assembly known in the art that facilitates capturing CO₂ by the systems described herein. In some embodiments, the pressure assembly 308 may be a vacuum that includes one or more pumps (not shown), such as, but not limited to, liquid ring pumps. In other embodiments, the pressure assembly 308 may be a blower.

The controller 124 facilitates modulating the pressure of one or more adsorption modules 104 by monitoring the pressure of the exhaust stream 312 from each adsorption module 104. For example, the controller 124 may monitor a regulated pressure P_{reg} of the exhaust stream 312 using a pressure sensor 316 (shown in FIG. 4). Additionally, for example, the controller 124 may monitor a control pressure P_{cntl} of one or more adsorption modules 104 using the module sensor 128 (shown in FIG. 4). In operating conditions wherein the control pressure P_{cntl} of one or more adsorption modules 104 is lower than desired, the controller 124 may facilitate increasing the regulated pressure P_{reg} of the exhaust stream 312, thereby increasing the pressure within at least one adsorption module 104. Alternatively, in operating conditions wherein the control pressure P_{cntl} of one or more adsorption modules 104 is higher than desired, the controller 124 may facilitate decreasing the regulated pressure Preg of the exhaust stream 312, thereby decreasing the pressure within the one or more adsorption module 104. The controller 124 may also monitor the concentration of CO₂ in exhaust stream 312 during desorption using the pressure sensor 316 (shown in FIG. 4).

Generally, the regulated pressure Preg of the exhaust stream 312, and thus the control pressure P_{cntl} of the adsorption module 104, may be any suitable pressure known in the art that facilitates desorption of CO₂ by the systems described herein. In some embodiments, the regulated pressure P_{reg} of the exhaust stream 312 may be in a range of from about 0.05 bara to about 2 bara. In other embodiments, the regulated pressure P_{reg} of the exhaust stream 312 may be in a range of from about 0.4 bara to about 1 bara. The controller 124 may facilitate increasing the regulated pressure P_{reg} of the exhaust stream 312 by varying the output of the pressure assembly 308. Alternatively, the controller 124 may facilitate decreasing the regulated pressure P_{reg} of the exhaust stream 312 by varying the output from the pressure assembly 308.

In the exemplary embodiment, the controller 124 may control the flow of the gas stream 110 into one or more adsorbent beds 102a-c through control of inlet valves 304a-c. The selective use of one or more adsorbent beds 102 to capture CO₂ from the gas stream 110 may facilitate optimizing the efficiency of the capture system 300. For example, the controller 124 may us a minimum number of adsorbent beds 102a-c as needed to facilitate optimizing the capture of CO₂ from the gas stream 110. Accordingly, flow of the gas stream 110 into one or more adsorbent beds 102a-c may be adjusted by the controller 124 by selectively opening and/or closing at least one inlet valve 304a-c. Additionally, for example, the controller 124 may use more than one of adsorbent beds 102a-c in series to optimize the capture of CO₂ from the gas stream 110. Accordingly, the flow of the gas stream 110 into and out of the adsorbent beds 102 may be variably adjusted by the controller 124 by selectively opening and/or closing one or more inlet valves 304a-c.

In the exemplary embodiment, the controller 124 facilitates adsorbing and desorbing CO₂ via the capture system 300 to facilitate optimizing an amount of CO₂ captured from the gas stream 110. The controller 124 may variably adjust the control temperature T_{cntl} of one or more adsorption modules 104 to facilitate increasing the amount of CO₂ captured and released by the sorbent 116. Setting the control temperature T_{cntl} of one or more adsorption modules 104 at a lower temperature may facilitate increasing the amount of CO₂ adsorbed by the sorbent 116. That is, in some embodiments, the adsorption performance of the sorbent 116 may be improved by maintaining the control temperature T_{cntl} of one or more adsorption module 104 at a lower temperature. Additionally, setting the control temperature T_{cntl} of one or more adsorption modules 104a-d at a higher temperature may facilitate increasing an amount of CO₂ desorbed by the sorbent 116. That is, the desorption performance of the sorbent 116 may be improved by increasing the control temperature T_{cntl} of one or more adsorption modules 104a-d from the lower temperature used for adsorption to a higher temperature for desorption.

Setting the control temperature T_{cntl} of one or more adsorption module 104 to a lower temperature may facilitate increasing the amount of CO₂ adsorbed by the sorbent 116 by offsetting the heat generated during adsorption. That is, using the regulated temperature T_{reg} of the first stream 122 to indirectly cool at least one adsorption module 104a-d may facilitate increasing the efficiency and duration of adsorption, thereby improving the adsorption performance of the sorbent 116. Additionally, using the regulated temperature T_{reg} of the first stream 122 to vary the control temperature T_{cntl} across one or more adsorption modules 104a-d may facilitate increasing the efficiency and duration of adsorption in the adsorption modules 104a-d, thereby improving the adsorption performance of the sorbent 116 within the adsorption modules 104a-d having the highest concentrations of CO₂ in the gas stream 110 flowing therethrough.

The controller 124 may also adjust the control pressure Pent of one or more adsorption modules 104a-d to facilitate increasing an amount of CO₂ desorbed by the sorbent 116. Setting the control pressure P_{cntl} of one or more adsorption modules 104a-d at a lower pressure may facilitate increasing the amount of CO₂ desorbed by the sorbent 116. That is, the desorption performance of the sorbent 116 may be improved by decreasing the control pressure P_{cntl} of one or more adsorption modules 104a-d. In the exemplary embodiment, the controller 124 adjusts the control pressure P_{cntl} of one or more adsorption modules 104a-d for desorption of CO₂ from sorbent 116.

In the exemplary embodiment, the controller 124 facilitates optimizing the amount of CO₂ captured from the gas stream 110 by adjusting both the control temperature T_{cntl} and the control pressure Penti of one or more adsorption modules 104a-d. The controller 124 may increase the control temperature T_{cntl} and decrease the control pressure P_{cntl} of one or more adsorption modules 104a-d concurrently to facilitate increasing an amount of CO₂ desorbed by the sorbent 116. In some embodiments, the controller 124 may adjust the control temperature T_{cntl} and the control pressure P_{cntl} of one or more adsorption modules 104a-d for preset durations of time to facilitate optimizing the amount of CO₂ captured from the gas stream 110. For example, the controller 124 may increase the control temperature T_{cntl} and decrease the control pressure P_{cntl} of one or more adsorption modules 104a-d for a first predefined time duration, and may then maintain the control temperature T_{cntl} and the control pressure P_{cntl} at the modified values for a second predefined time duration. In other embodiments, the controller 124 may adjust the control temperature T_{cntl} and the control pressure P_{cntl} of one or more adsorption modules 104a-d based on signals received from the contactor sensor 126, the module sensor 128, and/or the pressure sensor 316. For example, at least one of the contactor sensor 126, the module sensor 128, and/or the pressure sensor 316 may transmit a signal to the controller 124 indicating the start and/or end of an adsorption and/or desorption cycle.

In some embodiments, the control temperature T_{cntl} may be substantially uniform across each adsorption module 104. In other embodiments, the control temperature T_{cntl} may vary for any of the adsorption modules 104. For example, the controller 124 may facilitate increasing the control temperature T_{cntl} for the first adsorbent module 104a in a series of adsorbent modules 104 that receive gas stream 110. Additionally, for example, the controller 124, as compared to the adsorbent module 104a, may decrease the control temperature T_{cntl} for the second adsorbent module 104b coupled in series downstream from the adsorbent module 104a.

FIG. 4 is a schematic of an exemplary control system 400 that may be used to capture CO₂ with a capture system, such as the capture system 100 (shown in FIG. 1) and/or the capture system 300 (shown in FIG. 3). In the exemplary embodiment, the controller 124 includes a memory 402 and a processor 404. The controller 124 may adjust the temperature of one or more adsorption modules 104a-d based on data received by the control system 400 from the contactor sensor 126, such as, but not limited to, the regulated temperature T_{reg} of the first stream 122 (shown in FIG. 1). The controller 124 may adjust the temperature of one or more adsorption modules 104a-d based on comparisons to data stored in the memory 402, such as desired ranges of the regulated temperature T_{reg}, instructions stored in the memory 402, and/or data analyzed by the processor 404.

Additionally, the controller 124 may adjust the temperature of one or more adsorption modules 104a-d based on data received by the control system 400 from the module sensor 128, such as, but not limited to, the control temperature T_{cntl} of one or more adsorption modules 104. The controller 124 may adjust the temperature of one or more adsorption modules 104 based on comparisons to data stored in the memory 402, such as desired ranges of the control temperature T_{cntl}, instructions stored in the memory 402, and/or data analyzed by the processor 404.

Exemplary systems for using changes in temperature and pressure to optimize the adsorption and desorption of carbon dioxide by an adsorbent bed are described herein. The exemplary systems as described herein provide several advantages over conventional designs and processes, including, at least, minimizing the contamination of the sorbent enabled by the use of convection between the first stream flowing within the fluid circuit of the contactor and the sorbent coated on the plate of the adsorbent bed, increasing the efficiency and performance of carbon dioxide adsorption due to the use of changes in temperature of the adsorbent bed, increasing the efficiency and performance of carbon dioxide desorption due to the use of changes in both temperature and pressure of the adsorbent bed, and increasing the performance of the capture system due to the use of multiple adsorbent beds connected in series by valves.

The above description is meant to be exemplary only, and one skilled in the art will recognize that changes may be made to the embodiments described without departing from the scope of the invention disclosed. Modifications, which fall within the scope of the present invention, will be apparent to those skilled in the art, in light of a review of this disclosure, and such modifications are intended to fall within the appended claims. The systems described herein are not limited to the specific embodiments described herein, but rather portions of the various systems may be utilized independently and separately from other systems described herein.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

Further aspects of the invention are provided by the subject matter of the following clauses:

A capture system for use in capturing carbon dioxide, the capture system comprising: at least one adsorbent bed comprising a sorbent, the at least one adsorbent bed oriented to: receive a gas stream; adsorb carbon dioxide from the gas stream via the sorbent; and discharge an exhaust stream; a contactor in close proximity to the adsorbent bed, the contactor oriented to receive a regulating fluid for use in indirectly controlling a temperature of the adsorbent bed; a pressure assembly oriented to control a pressure of the exhaust stream discharged from the adsorbent bed; and a controller configured to modulate the temperature and the pressure of the adsorbent bed to facilitate increasing an amount of carbon dioxide captured by the capture system.

The capture system in accordance with any of the preceding clauses, wherein the adsorbent bed comprises a plate coated with the sorbent.

The capture system in accordance with any of the preceding clauses, wherein the contactor comprises a fluid circuit in close proximity to the plate, the fluid circuit oriented to receive the regulating fluid to indirectly control the temperature of the sorbent.

The capture system in accordance with any of the preceding clauses, further comprising a valve upstream from the adsorbent bed, wherein the controller is further configured to modulate the pressure of the exhaust stream discharged from the adsorbent bed by selectively opening or closing the valve.

The capture system in accordance with any of the preceding clauses, wherein the at least one adsorbent bed comprises a plurality of adsorbent beds coupled in a series flow arrangement, wherein the controller is further configured to modulate the pressure of the exhaust stream discharged from each of the plurality of adsorbent beds by selectively opening or closing at least one valve upstream from the plurality of adsorbent beds.

The capture system in accordance with any of the preceding clauses, wherein the pressure assembly is downstream from the at least one adsorbent bed.

The capture system in accordance with any of the preceding clauses, further comprising a pressure valve coupled between the at least one adsorbent bed and the pressure assembly, wherein the controller is further configured to modulate the pressure of the exhaust stream discharged from the at least one adsorbent bed by selectively opening or closing the pressure valve.

The capture system in accordance with any of the preceding clauses, wherein the at least one adsorbent bed comprises a plurality of adsorbent beds coupled in a series flow arrangement, wherein the controller is further configured to modulate the pressure of the exhaust stream discharged from each of the plurality of adsorbent beds by selectively opening or closing the pressure valve downstream from at least one of the plurality of adsorbent beds.

The capture system in accordance with any of the preceding clauses, wherein the controller is further configured to decrease the temperature of the at least one adsorbent bed to facilitate increasing efficiency of the capture system by increasing the amount of carbon dioxide adsorbed by the sorbent.

The capture system in accordance with any of the preceding clauses, wherein the controller is further configured to increase the temperature and decrease the pressure of the at least one adsorbent bed to facilitate increasing efficiency of the capture system by increasing the amount of carbon dioxide desorbed by the sorbent.

The capture system in accordance with any of the preceding clauses, wherein the pressure assembly is a vacuum pump.

The capture system in accordance with any of the preceding clauses, wherein the pressure assembly is a blower.

A capture system for use in capturing carbon dioxide, the capture system comprising: at least one adsorbent bed comprising a plate coated with a sorbent, the at least one adsorbent bed oriented to: receive a gas stream; adsorb carbon dioxide from the gas stream via the sorbent; and discharge an exhaust stream; a contactor in close proximity to the adsorbent bed, the contactor oriented to receive a regulating fluid for use in indirectly controlling a temperature of the adsorbent bed; a pressure assembly oriented to control a pressure of the exhaust stream discharged from the adsorbent bed; and a controller configured to modulate the temperature and the pressure of the adsorbent bed to facilitate increasing an amount of carbon dioxide captured by the capture system.

The capture system in accordance with any of the preceding clauses, wherein the contactor comprises a fluid circuit in close proximity to the plate, the fluid circuit oriented to receive the regulating fluid to indirectly control the temperature of the sorbent.

The capture system in accordance with any of the preceding clauses, further comprising a valve upstream from the adsorbent bed, wherein the controller is further configured to modulate the pressure of the exhaust stream discharged from the adsorbent bed by selectively opening or closing the valve.

The capture system in accordance with any of the preceding clauses, wherein the pressure assembly is downstream from the at least one adsorbent bed.

The capture system in accordance with any of the preceding clauses, further comprising a pressure valve coupled between the at least one adsorbent bed and the pressure assembly, wherein the controller is further configured to modulate the pressure of the exhaust stream discharged from the at least one adsorbent bed by selectively opening or closing the pressure valve.

The capture system in accordance with any of the preceding clauses, wherein the controller is further configured to decrease the temperature of the at least one adsorbent bed to facilitate increasing efficiency of the capture system by increasing the amount of carbon dioxide adsorbed by the sorbent.

The capture system in accordance with any of the preceding clauses, wherein the controller is further configured to increase the temperature and decrease the pressure of the at least one adsorbent bed to facilitate increasing efficiency of the capture system by increasing the amount of carbon dioxide desorbed by the sorbent.

The capture system in accordance with any of the preceding clauses, wherein the pressure assembly is a vacuum pump.

While the invention has been described in terms of various specific embodiments, those skilled in the art will recognize that the invention can be practiced with modification within the spirit and scope of the claims.

What is claimed is:

1. A capture system for use in capturing carbon dioxide, the capture system comprising:
at least one adsorbent bed comprising a sorbent, the at least one adsorbent bed oriented to:
receive a gas stream;
adsorb carbon dioxide from the gas stream via the sorbent; and
discharge an exhaust stream;
a contactor in close proximity to the adsorbent bed, the contactor oriented to receive a regulating fluid for use in indirectly controlling a temperature of the adsorbent bed;
a pressure assembly oriented to control a pressure of the exhaust stream discharged from the adsorbent bed; and
a controller configured to modulate the temperature and the pressure of the adsorbent bed to facilitate increasing an amount of carbon dioxide captured by the capture system.

2. The capture system in accordance with claim 1, wherein the adsorbent bed comprises a plate coated with the sorbent.

3. The capture system in accordance with claim 2, wherein the contactor comprises a fluid circuit in close proximity to the plate, the fluid circuit oriented to receive the regulating fluid to indirectly control the temperature of the sorbent.

4. The capture system in accordance with claim 1, further comprising a valve upstream from the adsorbent bed, wherein the controller is further configured to modulate the pressure of the exhaust stream discharged from the adsorbent bed by selectively opening or closing the valve.

5. The capture system in accordance with claim 4, wherein the at least one adsorbent bed comprises a plurality of adsorbent beds coupled in a series flow arrangement, wherein the controller is further configured to modulate the pressure of the exhaust stream discharged from each of the plurality of adsorbent beds by selectively opening or closing at least one valve upstream from the plurality of adsorbent beds.

6. The capture system in accordance with claim 1, wherein the pressure assembly is downstream from the at least one adsorbent bed.

7. The capture system in accordance with claim 6, further comprising a pressure valve coupled between the at least one adsorbent bed and the pressure assembly, wherein the controller is further configured to modulate the pressure of the exhaust stream discharged from the at least one adsorbent bed by selectively opening or closing the pressure valve.

8. The capture system in accordance with claim 7, wherein the at least one adsorbent bed comprises a plurality of adsorbent beds coupled in a series flow arrangement, wherein the controller is further configured to modulate the pressure of the exhaust stream discharged from each of the plurality of adsorbent beds by selectively opening or closing the pressure valve downstream from at least one of the plurality of adsorbent beds.

9. The capture system in accordance with claim 1, wherein the controller is further configured to decrease the temperature of the at least one adsorbent bed to facilitate increasing efficiency of the capture system by increasing the amount of carbon dioxide adsorbed by the sorbent.

10. The capture system in accordance with claim 1, wherein the controller is further configured to increase the temperature and decrease the pressure of the at least one adsorbent bed to facilitate increasing efficiency of the capture system by increasing the amount of carbon dioxide desorbed by the sorbent.

11. The capture system in accordance with claim 1, wherein the pressure assembly is a vacuum pump.

12. The capture system in accordance with claim 1, wherein the pressure assembly is a blower.

13. A capture system for use in capturing carbon dioxide, the capture system comprising:
at least one adsorbent bed comprising a plate coated with a sorbent, the at least one adsorbent bed oriented to:
receive a gas stream;
adsorb carbon dioxide from the gas stream via the sorbent; and
discharge an exhaust stream;
a contactor in close proximity to the adsorbent bed, the contactor oriented to receive a regulating fluid for use in indirectly controlling a temperature of the adsorbent bed;
a pressure assembly oriented to control a pressure of the exhaust stream discharged from the adsorbent bed; and
a controller configured to modulate the temperature and the pressure of the adsorbent bed to facilitate increasing an amount of carbon dioxide captured by the capture system.

14. The capture system in accordance with claim 13, wherein the contactor comprises a fluid circuit in close proximity to the plate, the fluid circuit oriented to receive the regulating fluid to indirectly control the temperature of the sorbent.

15. The capture system in accordance with claim 13, further comprising a valve upstream from the adsorbent bed, wherein the controller is further configured to modulate the pressure of the exhaust stream discharged from the adsorbent bed by selectively opening or closing the valve.

16. The capture system in accordance with claim 13, wherein the pressure assembly is downstream from the at least one adsorbent bed.

17. The capture system in accordance with claim 16, further comprising a pressure valve coupled between the at least one adsorbent bed and the pressure assembly, wherein the controller is further configured to modulate the pressure of the exhaust stream discharged from the at least one adsorbent bed by selectively opening or closing the pressure valve.

18. The capture system in accordance with claim 13, wherein the controller is further configured to decrease the temperature of the at least one adsorbent bed to facilitate increasing efficiency of the capture system by increasing the amount of carbon dioxide adsorbed by the sorbent.

19. The capture system in accordance with claim 13, wherein the controller is further configured to increase the temperature and decrease the pressure of the at least one adsorbent bed to facilitate increasing efficiency of the capture system by increasing the amount of carbon dioxide desorbed by the sorbent.

20. The capture system in accordance with claim 13, wherein the pressure assembly is a vacuum pump.
